(19) United States
(12) Patent Application Publication
(10) Pub. No.: US 2019/0026829 A1
(43) Pub. Date: Jan. 24, 2019

(54) TRADING SYSTEM, PROVIDER TERMINAL, USER TERMINAL, AND NODE

(71) Applicant: DENSO CORPORATION, Kariya-city (JP)

(72) Inventors: Tsuneo NAKATA, Kariya-city (JP); Takashi UEFUJI, Kariya-city (JP); Tomoya OGAWA, Kariya-city (JP); Hiroyuki KISHITA, Kariya-city (JP)

(21) Appl. No.: 16/042,230

(22) Filed: Jul. 23, 2018

(30) Foreign Application Priority Data
Jul. 24, 2017 (JP) 2017-143008
Jul. 20, 2018 (JP) 2018-136971

(51) Int. Cl. G06Q 40/04; G06Q 20/38; H04L 9/32; H04L 29/08

(52) U.S. Cl. CPC G06Q 40/04; G06Q 20/3827; H04L 2209/38; H04L 67/1097; H04L 9/3236

(57) ABSTRACT

In a ledger execution unit of a distributed ledger system, a node communicates with a provider terminal to thereby execute a transaction, and a node communicates with a user terminal to thereby execute a transaction. A storage unit is configured in such a way that at least one of the nodes generates a new distributed information item indicative of a record of the transactions, and each of the nodes stores the new distributed information item.

### CROSS REFERENCE TO RELATED APPLICATIONS

This application is based on and claims the benefit of priority from Japanese Patent Applications 2017-143008 filed on Jul. 24, 2017 and 2018-136971 filed on Jul. 20, 2018, the disclosure of which is incorporated in its entirety herein by reference.

### TECHNICAL FIELD

The present disclosure relates to technologies for registering, into a distributed ledger system, information associated with transactions carried out between provider terminals and user terminals.

### BACKGROUND

There is known an information bank, which manages the giving and receiving of information between information providers and information users. Such an information bank is disclosed in, for example, non-patent literature 1, which is HIDEKI SUNAHARA, MASATO YAMANOUCHI, HIROSHI KANASUGI, and RYOSUKE SHIBASAKI: Concept of “Information Bank” and its Technical Issues, Multimedia, Distributed, Cooperative, and Mobile Symposium (DICOMO) 2014 symposium, July 2014, p. 1024-1026.

### SUMMARY

Unfortunately, there may be a possibility of malicious staff of an information bank falsifying records of the giving and receiving of information between information providers and information users. This may make it difficult for the information providers and information users to trust, to the information bank, management of the giving and receiving of information between the information providers and information users.

Additionally, information has attributes, i.e. qualities or characteristics, thereabout. The purpose of use of a first piece of information may be different from the purpose of use of a similar second piece of information if the attributes of the first piece of information are different from the attributes of the second piece of information. This feature of information is strongly different from for example money. Additionally, the importance or value of information is variable depending on external factors.

That is, the importance or value of information is determined based on its qualitive criteria, such as attributes, independently of its quantitative criteria, such as its size or entropy, resulting in the importance or value of information being in flux.

The non-patent literature 1 may however not sufficiently consider

(1) The risk of falsification of information

(2) The liquidity of information

This may therefore result in interference with performing information transactions carried out between provider terminals and user terminals.

The present disclosure aims to address at least part of the problem set forth above, and provides technologies for conducting useful information transactions between information providers and information uses.

According to a first exemplary aspect of the present disclosure, there is provided a trading system. The trading system includes a distributed ledger system, and a plurality of terminals that includes at least one provider terminal and at least one user terminal. The distributed ledger system includes a plurality of nodes communicably connected to one another. The distributed ledger system is configured in such a way that each of the nodes has commonly stored a plurality of distributed information items therein associated with transactions related to useful information items. The at least one provider terminal includes a provider communicator communicable with a node, and a provider execution unit configured to communicate with a node via the provider communicator to thereby perform processing for a transaction associated with a provision of a new useful information item through the distributed ledger system. The at least one user terminal includes a user communicator communicable with a node, and a user execution unit configured to communicate with a node via the user communicator to thereby perform processing for a request of a transaction associated with a usage of a specified useful information item in the registered useful information items through the distributed ledger system.

The distributed ledger system includes a ledger execution unit configured in such a way that any one of the nodes communicates with the at least one provider terminal to thereby execute the corresponding one of the transactions. The distributed ledger system includes a ledger storage unit configured in such a way that at least one of the nodes generates a new distributed information item indicative of a record of each of the transactions, and each of the nodes stores the new distributed information item. The new distributed information item includes a transaction information item indicative of the record of each of the transactions, and a unique information item generated based on another distributed information item generated immediately before the new distributed information item.

The trading system is configured to store, into the distributed ledger system, a record of each of the transactions about useful-information items carried out via the terminals and the distributed ledger system as a transaction information item. In particular, the distributed ledger system is configured in such a way that an identical set of distributed information items including the transaction information items is shared among all the nodes.

Each of the distributed information items stored in each node includes the unique information item generated immediately before the new distributed information items.

This configuration of the trading system therefore makes it difficult to tamper with the distributed information items stored in the distributed ledger system, thus ensuring the reliability of the transaction information items included in the respective distributed information items.

That is, the trading system is configured to accurately store a record of user's actions and user's intentions indicated in a transaction of a useful information item in the distributed ledger system. This configuration prevents a user, who performs a transaction of the useful information item, from suffering unexpected disadvantage, even if the value of the useful information item has varied. This therefore enables users to perform, with peace of mind, transactions of the useful information items stored in the distributed ledger system, making it possible to invigorate transactions of useful information items.

Note that a second exemplary aspect of the present disclosure is the provider terminal in the trading system according to the first exemplary aspect. In addition, a third exemplary aspect of the present disclosure is the user terminal in the trading system according to the first exemplary aspect.

According to a fourth exemplary aspect of the present disclosure, there is provided a node included in a plurality of nodes of a distributed ledger system. The nodes are connected to one another. The distributed ledger system is configured in such a way that each of the nodes has commonly registered a plurality of distributed information items therein associated with transactions related to useful information items.

The node includes a node storage configured to store the distributed information items, a node communicator configured to communicate with terminals and other nodes.

The node executing unit is configured to execute a transaction process of a transaction requested from a terminal. The node includes a node storage unit configured to generate and store in the node storage unit a new distributed information item. The new distributed information item includes a transaction information item indicative of the record of each of the transactions, and a unique information item generated based on another distributed information item generated immediately before the new distributed information item.

These nodes constitute the distributed ledger system. Using the distributed ledger system, the provider terminal, and the user terminal enables the same effects as those achieved by the first exemplary aspect to be achieved.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the configuration of a trading system according to a present embodiment of the present disclosure;

FIG. 2 is a block diagram schematically illustrating an example of the configuration of an in-vehicle system in which at least one provider terminal is installed in a vehicle;

FIG. 3 is a block diagram schematically illustrating an example of the configuration of the at least one provider terminal;

FIG. 4 is a block diagram schematically illustrating an example of the configuration of at least one user terminal;

FIG. 5 is a block diagram schematically illustrating an example of the configuration of at least one management terminal;

FIG. 6 is a block diagram schematically illustrating distributed information items stored in a distributed ledger system illustrated in FIG. 1;

FIG. 7A is a sequential diagram schematically illustrating a first transaction sequence carried out in the trading system;

FIG. 7B is a flowchart schematically illustrating how each of nodes performs a registering task of the first transaction sequence in accordance with a distributed consensus algorithm;

FIG. 8 is a sequential diagram schematically illustrating a second transaction sequence carried out in the trading system;

FIG. 9A is a sequential diagram schematically illustrating a third transaction sequence carried out in the trading system;

FIG. 9B is a flowchart schematically illustrating how each of the nodes performs a registering task of the third transaction sequence in accordance with the distributed consensus algorithm;

FIG. 10 is a sequential diagram schematically illustrating a fourth transaction sequence carried out in the trading system; and

FIG. 11 is a sequential diagram schematically illustrating a fifth transaction sequence carried out in the trading system.

### DETAILED DESCRIPTION OF EMBODIMENT

The following describes a present embodiment of the present disclosure with reference to the accompanying drawings.

### Configuration

The following describes an example of the configuration of a trading system 1 according to the predetermined embodiment of the present disclosure.

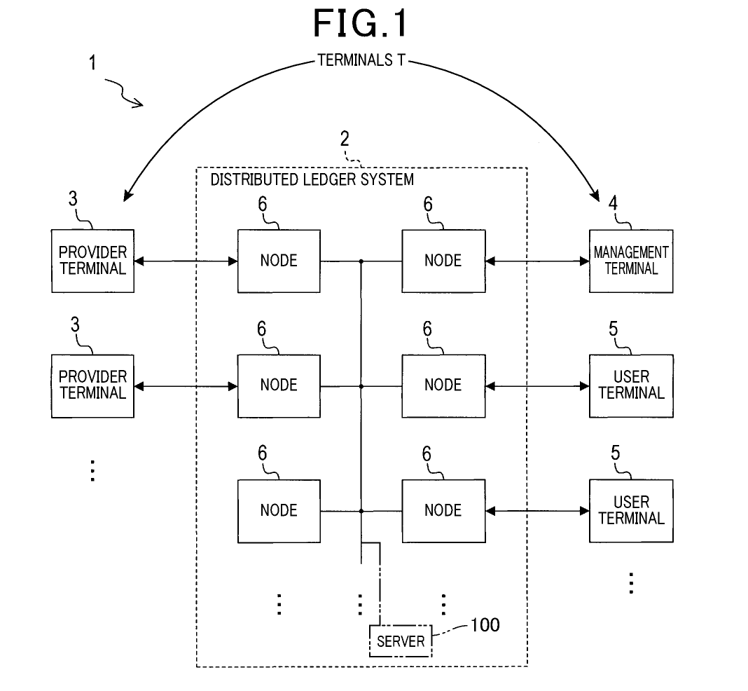

Referring to FIG. 1, the trading system 1 includes a plurality of terminals, which are collectively referred to as terminals T, and a plurality of nodes, such as processing nodes, 6. All the nodes 6 are communicably connected to one another to constitute a peer-to-peer network; the nodes 6 constitute a distributed ledger system 2.

The trading system 1 aims to storage, into the distributed ledger system 2, information items, i.e. transaction information items, that are respectively associated with useful or variable information transactions; the useful or variable information transactions have been carried out among the terminals T with the need of the giving and receiving of electrical charge thereamong. A useful or variable information item will be simply referred to as a useful information item. The number of nodes 6 is preferably set to three or more, and the nodes 6 are preferably managed by different managers. Specific examples of the useful information will be described later.

The terminals T included in the transaction system 1 include at least one provider terminal 3 that provides a useful information item, and at least one user terminal 5 that uses the useful information item. An identical terminal can be configured as both the provider terminal 3 and user terminal 5.

The at least one provider terminal 3 and the at least one user terminal 5 carry out useful-information transactions therebetween via the distributed ledger system 2. The distributed ledger system 2 is configured to record therein records of one or more transactions that have been carried out by the terminals T and the distributed ledger system 2 in association with the useful-information transactions.

The terminals T included in the transaction system 1 may also include at least one management terminal 4 controllable by at least one manager. When operated by the at least one manager, the at least one management terminal 4 is capable of accessing the nodes 6 in the distributed ledger system 2 to thereby perform management of the trading system 1. The at least one manager can operate the nodes 6 directly to thereby perform management of the trading system 1.

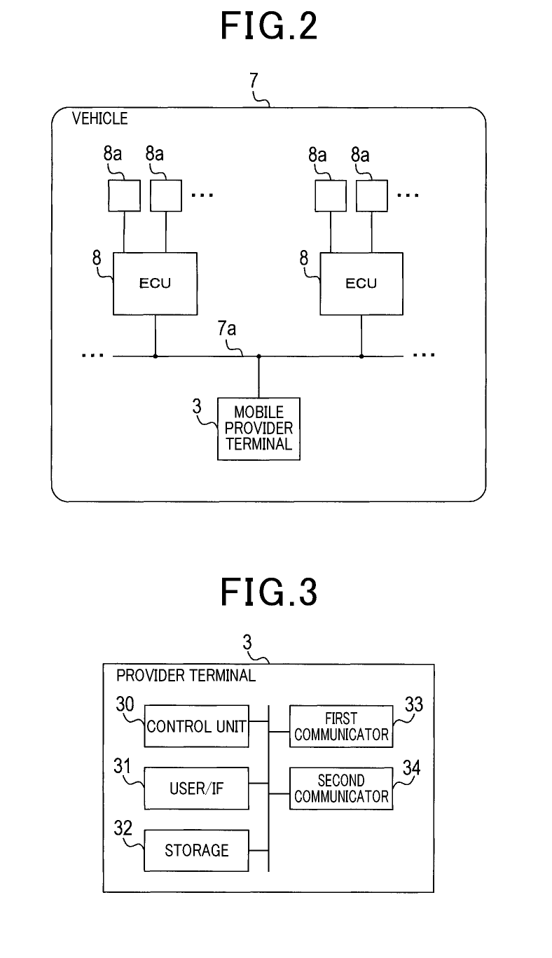

Each of the terminals T can be designed as a programmable logic device, such as a personal computer or a mobile terminal. For example, a smartphone can be used as a terminal. As illustrated in FIG. 2, the at least one provider terminal 3 can be designed as a mobile provider terminal installed in a movable object. For example, as illustrated in FIG. 2, the at least one provider terminal 3 can be installed in a vehicle, such as an automobile, 7 as an example of a movable object.

In this example illustrated in FIG. 2, the at least one provider terminal 3 constitutes an electronic control unit (ECU) communicably connected to one or more other ECUs 8 via a local area network (LAN) 7a installed in the vehicle 7; the one or more other ECUs 8 are each provided with one or more in-vehicle devices, such as sensors 8a. The one or more sensors 8a are each configured to measure vehicular information associated with the operations of the vehicle 7 and environment information around the vehicle 7.

The at least one provider terminal 3 communicates with the one or more other ECUs 8 to thereby obtain, from the one or more other ECUs 8, various pieces of information, such as the corresponding vehicular information. The at least one provider terminal 3 can include functions included in an available ECU, or can include an available navigation system. Thereafter, the at least one provider terminal 3 and the at least one other ECU 8 can be collectively referred to as at least one provider ECU. A user of the at least one provider terminal 3 can be an owner of the vehicle 7 in which the at least one provider terminal 3 is installed, or can be a rental company of the vehicle 7.

Next, the following describes an example of the configuration of the at least one provider terminal 3 with reference to FIG. 3.

The at least one provider terminal 3 includes a control unit 30, a user interface (I/F) 31, a storage 32, a first communicator 33, and a second communicator 34. These elements are communicably connected with each other.

The control unit 30 is configured as a computer circuit comprised of a CPU and a memory device that includes, for example, at least one of semiconductor memories, such as a RAM, a ROM, and a flash memory. These semiconductor memories are examples of non-transitory computer-readable storage media.

For example, the CPU of the control unit 30 can run one or more programs, i.e. program instructions, stored in the memory device to thereby cause the CPU to perform functions of the at least one provider terminal 3. At least one of the functions of the at least one provider terminal 3 can be implemented as a hardware electronic circuit. For example, the various functions of the at least one provider terminal 3 can be implemented by a combination of electronic circuits including digital circuits, which include many logic gates, analog circuits, digital/analog hybrid circuits, or hardware/software hybrid circuits.

The user I/F 31 includes an input device that enables a user to input various pieces of information to the control unit 30. The input device of the user I/F 31 can be comprised of a touch panel, plural buttons, a keyboard, and/or a pointing device. The user I/F 31 also includes an information device including, for example a display and/or a speaker. The information device is configured to provide, to a user of the at least one provider terminal 3, visible and/or audible information.

The storage 32 is comprised of a non-volatile readable and writable storage media, such as a hard disc drive or a flash memory.

The first communicator 33 is configured to access at least one of various available networks, such as the internet, via cables or radio waves to thereby communicate with the nodes 6 and/or the other terminals via the at least one of the various available networks.

The second communicator 34 is configured to communicate with other devices installed in the at least one provider terminal 3. Specifically, if the at least one provider terminal 3 is configured as a mobile provider terminal installed in the vehicle 7, the second communicator 34 can communicate with the at least one other ECU 8 via the LAN 7a. The second communicator 34 can be omitted from the at least one provider terminal 3.

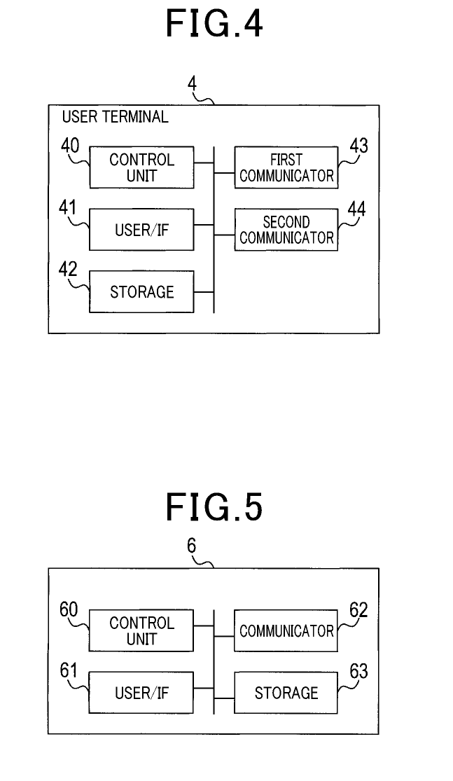

Referring to FIG. 4, the at least one user terminal 5 includes a control unit 30, a user I/F 31, a storage 32, a first communicator 33, and a second communicator 34, which is similar to the at least one provider terminal 3. The at least one management terminal 4 has the same configuration as the at least one provider terminal 3 and the at least one user terminal 5. The descriptions of the at least one management terminal 4 and the at least one user terminal 5 are therefore omitted.

Each node 6 can be designed as a programmable logic device, such as a personal computer.

Referring to FIG. 5, each node 6 includes a control unit 60, a user I/F 61, a communicator 62, and a storage 63. These elements are communicably connected with each other.

The control unit 60 is configured as a computer circuit comprised of a CPU and a memory device that includes, for example, at least one of semiconductor memories, such as a RAM, a ROM, and a flash memory. These semiconductor memories are examples of non-transitory storage media.

For example, the CPU of the control unit 60 can run one or more programs, i.e. program instructions, stored in the memory device to thereby cause the CPU to perform functions of the at least one provider terminal 3. At least one of the functions of the node 6 can be implemented as a hardware electronic circuit. For example, the various functions of the node 6 can be implemented by a combination of electronic circuits including digital circuits, which include many logic gates, analog circuits, digital/analog hybrid circuits, or hardware/software hybrid circuits.

The user I/F 61 includes an input device that enables a user to input various pieces of information to the control unit 60. The input device of the user I/F 61 can be comprised of a touch panel, plural buttons, a keyboard, and/or a pointing device. The user I/F 61 also includes an information device including, for example a display and/or a speaker. The information device is configured to provide, to a user of the node 6, visible and/or audible information.

The communicator 62 of each node 6 is configured to access at least one of various available networks, such as the internet, via cables or radio waves to thereby communicate with the other nodes 6 and/or the terminals T via the at least one of the various available networks.

The storage 63 is comprised of a non-volatile readable and writable storage media, such as a hard disc drive or a flash memory.

### Distributed Ledger System

The distributed ledger system 2 can be operated by, for example, an operating company of the trading system 1, a manufacturer of at least one of the terminals T, a manufacturer of a movable object if the at least one provider terminal 3 is installed in the movable object, a user of useful information, or a communication carrier. Each of these companies, manufacturers, or the carriers may manage at least one of corresponding nodes 6.

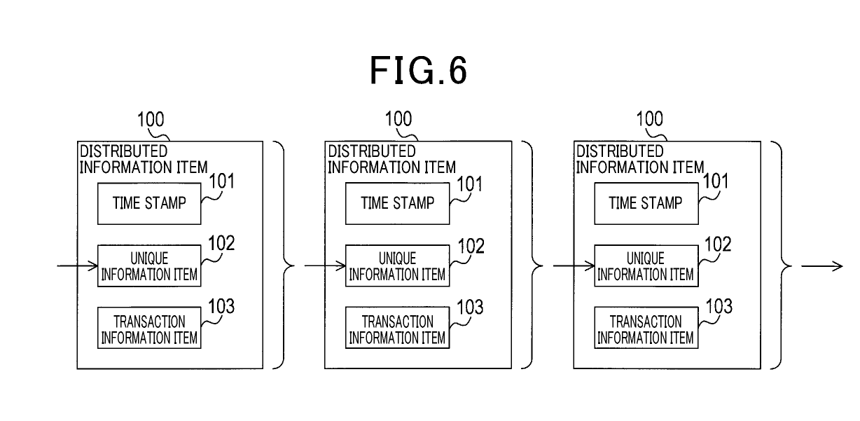

As described above, the distributed ledger system 2 is configured to record a transaction information item about a carried-out transaction into each node 6. Specifically, FIG. 6 schematically illustrates that a transaction information item is distributedly stored in the storages 63 of the respective nodes 6 as distributed information items 100. Each of the distributed information items 100 includes, for example, a time stamp 101 indicative of the date and time of the carried-out transaction, a unique information item 102, and a transaction information item 103 about the carried-out transaction.

Each of the terminals T is capable of communicating with a selected one of the nodes 6 to thereby request at least one transaction via the distributed ledger system 2. When the at least one transaction is carried out by, for example, the selected node 6, the selected node 6 communicates with the other nodes 6, so that each of the nodes 6 executes a storage task that stores, into the storage 63, a new distributed information item, such as a predetermined data item 100, including a transaction information item 103. The transaction information item 103 represents a record of the at least one transaction.

Specifically, the storage task executed by each node 6 is configured to

1. Generate a new transaction information item 103

2. Generate a time stamp 101 indicative of the present date and time at which the new transaction information item 103 was generated

3. Generate a new distributed information item 100 including the new transaction information item 103, the time stamp 101, and the unique information item 102

4. Store the new distributed information item 100 in the storage 63

Note that the unique information item 102 for each node 6 represents, for example, information uniquely generated by the node 6 based on a previous distributed information item 100 generated at immediately previous generation of the new transaction information item 103. For example, the unique information item 102 for each node 6 can include a hash value generated based on the previous distributed information item, i.e. previous distributed data, 100 in accordance with a predetermined hash function.

More specifically, each node 6 of the distributed ledger system 2 implements a predetermined distributed consensus algorithm used by, for example, an Ehtereum or a Hyperledger platform. The storage task executed by each node 6 is programmed to execute the distributed consensus algorithm to thereby store the generated distributed information item 100 in the storage 63.

This enables the identity and reliability of the pieces of distributed information 100 stored in the respective nodes 6 to be ensured.

For example, the distributed consensus algorithm can be configured to assign any one of the nodes 6 to generate new distributed information 100. In addition, the distributed consensus algorithm installed in each node 6 can be configured to

1. Achieve a consensus decision among the nodes 6 about whether new distributed information 100 generated by a node 6 is authentic or should be verified

2. Cause the corresponding node 6 to store the new distributed information item in the storage 63 when a consensus decision about that the new distributed information item 100 is authentic is achieved among the nodes 6

If the distributed consensus algorithm is carried out in a blockchain system, the distributed information item 100 corresponds to a block.

Thereafter, storing a new transaction information item at each node 6 as distributed information 100 as a result of storing task of distributed ledger system 2 will be referred to as registering the new transaction information item.

That is, when one of the terminals T performs a transaction via the distributed ledger system 2, a transaction information item indicative of a record of the transaction is registered in the distributed ledger system 2.

Some or all of transaction information item stored in the distributed ledger system 2 are configured to be sent to the transaction requestor node and one or more other nodes. Specifically, the distributed ledger system 2 can be configured to directly send a transaction information item to the transaction requestor node and one or more other nodes. As another example, the distributed ledger system 2 can include a server 100 communicable with the nodes 6, at least one node 6 can store a transaction information item into the server 100, and the server 100 can be configured to send the transaction information item to at least one of the terminals T upon the at least one of the terminals T accessing the server 100. At least one of the terminals T can be configured to access a selected one of the nodes 6 of the distributed ledger system 2, and the selected node 6 can be configured to send a transaction information item to the accessing terminal. When receiving a transaction information item, one or more terminals T can be configured to provide, to a user, visible and/or audible information representing the transaction information item.

Each node 6 can be programmed to execute a part or all of tasks executable thereby automatically or in response to the entry of a manager's instruction via the user I/F.

### Transactions

The at least one provider terminal 3 requests a transaction using the distributed ledger system 2 in response to a user's request; the transaction is associated with the provision of a useful information item. The at least one user terminal 5 requests a transaction with the distributed ledger system 2 in response to a user's request; the transaction is associated with the use of a useful information item.

Example of transactions, i.e. transaction sequences, executable by the at least one provider terminal 3 and/or the at least one user terminal 5 through the distributed ledger system 2 are

1. A transaction sequence to provide at least one useful information item

2. A transaction sequence associated with editing of at least one useful information item

3. A transaction sequence to obtain at least one useful information item

4. A transaction sequence to offer trading conditions about at least one useful information item

5. A transaction sequence associated with the giving and receiving of a payment based on a completed transaction

At least one of the terminals T communicates with a selected node 6 in the distributed ledger system 2 to thereby carry out one of five transaction sequence examples to the selected node 6.

At that time, the specifics of the requested transaction sequence to be performed between the at least one of the terminals T and the selected node 6 is known by the distributed ledger system 2. Then, a record indicative of the detail of the selected transaction sequence is registered as a transaction information item in the distributed ledger system 2. Specifically, a user's intention shown in the requested transaction sequence and/or actions carried out in association with the requested transaction sequence are registered as a transaction information item in the distributed ledger system 2. Many transactions other than the transaction sequence examples can be carried out via the distributed ledger system 2.

The following describes the five transaction sequence examples.

### Transaction Sequence to Provide Useful Information

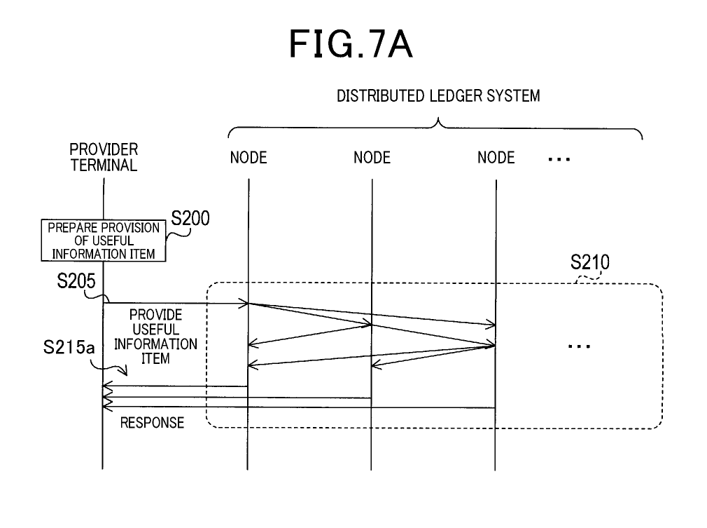

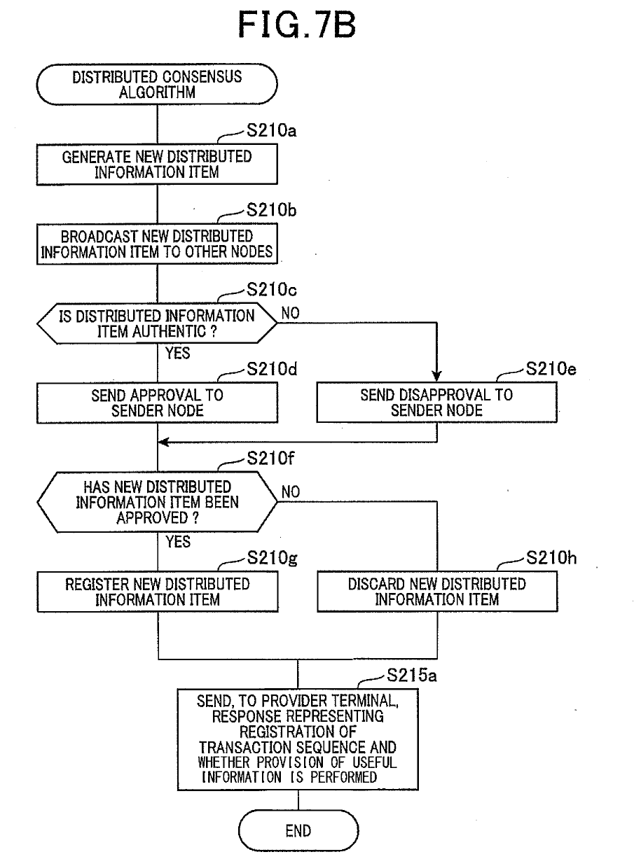

The following describes the first transaction sequence to provide a useful information item from the at least one provider terminal 3 with reference to FIGS. 7A and 7B.

When a user operates the user I/F 31 of the at least one provider terminal 3 to input a request to perform an information providing transaction that provides a useful information item, the at least one provider terminal 3 prepares the useful information item in step S200 in FIG. 7A. For example, the at least one provider terminal 3 can generate the useful information item by itself using, for example, information stored in the storage 32, or generate the useful information item based on information received from another device, such as the ECU 8, communicably connected thereto via the LAN 7a. Alternatively, the at least one provider terminal 3 can receive the useful information item generated by another device, such as the ECU 8, communicably connected thereto via the LAN 7a.

Next, the at least one provider terminal 3 performs processing to execute the information providing transaction to the distributed ledger system 2 in response to a user's instruction input from the user I/F 31 in step S205.

Specifically, the at least one provider terminal 3 communicates with a selected node 6 in the distributed ledger system 2 to thereby send notification of the information providing transaction to the selected node 6 in step S205.

In step S205, the at least one provider terminal 3 can send the useful information item itself to the selected node 6 directly, or indirectly by sending a notification linked to the useful information item. Specifically, the at least one provider terminal 3 can send, to the selected node 6, acquisition information as the notification; the acquisition information serves as a clue about the useful information item, thus reporting the existence of useful information item to the selected node 6 indirectly. The acquisition information can include, for example, a link to a predetermined location of a storage in which the useful information item is stored, or meta information for identifying the useful information item stored in a storage located at a predetermined address.

In step S205, the at least one provider terminal 3 can send, as the notification, the useful information item to the selected node 6 directly. In addition, the at least one provider terminal 3 can send, as the notification, information indicative of an intention to provide the useful information item to the selected node 6 without providing the useful information item to the selected node 6 in step S205.

The distributed ledger system 2 receives the notification sent from the at least one provider 3, and obtain, based on the notification, the useful information item in step S205.

Next, in step S210, at least one of the nodes 6 determines whether the useful information item is authentic.

Specifically, in step S210, at least one of the nodes 6 can determine whether the useful information item satisfies predetermined provision conditions. The details of the provision conditions for a useful information item to be traded will be described later. The provision conditions for an information item represent conditions that the information item should satisfy in order to be traded as a useful information.

When the useful information item is verified to satisfy the predetermined provision conditions, the distributed ledger system 2 executes the storage task to register a record of the transaction sequence including the information providing transaction, as a transaction information item 103 in step S210. The record of the transaction sequence is comprised of, for example, information that a user's intention of providing the useful information item is indicated, information that the useful information item has been provided, the acquisition information about the useful information item, and/or the useful information item itself.

As described above, the transaction record is registered to the distributed ledger system after execution of distributed consensus algorithm.

For example, when receiving the notification, the selected node 6 newly generates a distributed information item 100 including, for example, a time stamp 101, a unique information item 102, and a transaction information item 103 in step S210a (see FIG. 7B). The transaction information item 103 represents the record of the transaction sequence, and the timestamp 101 represents the date and time of the completed transaction sequence. The unique information item 102 represents information, such as a hash value, uniquely generated by the requested node 6 based on a previous transaction information item 103 included in a previous distributed information item 100 generated immediately previous generation of the new transaction information item 103.

Then, the selected node 6 broadcasts the distributed information item 100 to the other nodes 6 in step S210b. Each of the other nodes 6 receives the broadcasted distributed information item 100, and determines whether the received distributed information item 100 is authentic in step S210c. For example, each of the other nodes 6 determines whether the selected node 6, i.e. the sender node 6, is a valid node and/or whether the unique information item 102 included in the received distributed information item 100 is authentic in step S210c.

For example, if the unique information item 102 includes the hash value, each of the other nodes 6 calculates a hash value based on the received distributed information item 100, and determines whether the hash value 102 included in the received distributed information item 100 is identical to the calculated hash value. Upon determining that the hash value 102 included in the received distributed information item 100 is identical to the calculated hash value, each of the other nodes 6 determines that the received distributed information item 100 is authentic. Otherwise, upon determining that the hash value 102 included in the received distributed information item 100 is different from the calculated hash value, each of the other nodes 6 determines that the received distributed information item 100 is not authentic.

Upon determining that the received distributed information item 100 is authentic (YES in step S210c), each of the other nodes 6 sends approval about the provision of the useful information item to the selected node 6 in step S210d.

Otherwise, upon determining that the received distributed information item 100 is not authentic (NO in step S210c), each of the other nodes 6 sends disapproval about the provision of the useful information item to the selected node 6 in step S210e.

Upon receiving the consensuses and/or non-consensuses from all the other nodes 6, the selected node 6 determines whether the distributed information item 100 has been approved based on, for example, a majority rule in step S210f.

Specifically, if the number of the approvals is greater than the number of the disapprovals, the selected node 6 determines that the distributed information item 100 has been approved (YES in step S210f). Then, the selected node 6 registers, into the corresponding storage 63, a record of the approved distributed information item 100, and causes each of the other nodes 6 to register, into the corresponding storage 63, the approved distributed information item 100 in step S210g.

Otherwise, if the number of the disapprovals, i.e. rejections, is greater than the number of the approvals, the selected node 6 determines that the distributed information item 100 has been disapproved (NO in step S210f). Then, the selected node 6 discards the disapproved distributed information item 100, and causes each of the other nodes 6 to discard the disapproved distributed information item 100 in step S210h.

After the consensus operation in step S210g or S210h, each of the nodes 6 sends, to the at least one provider terminal 3, a response indicating registration of the record of the transaction sequence, and whether or not the provision of the useful information is performed in step S215a.

When receiving the response sent from each of the nodes 6, the at least one provider terminal 3 provides, to a user, visible and/or audible information representing the response sent from each of the nodes 6 in step S215a or S215b.

### Transaction Sequence to Edit Useful Information

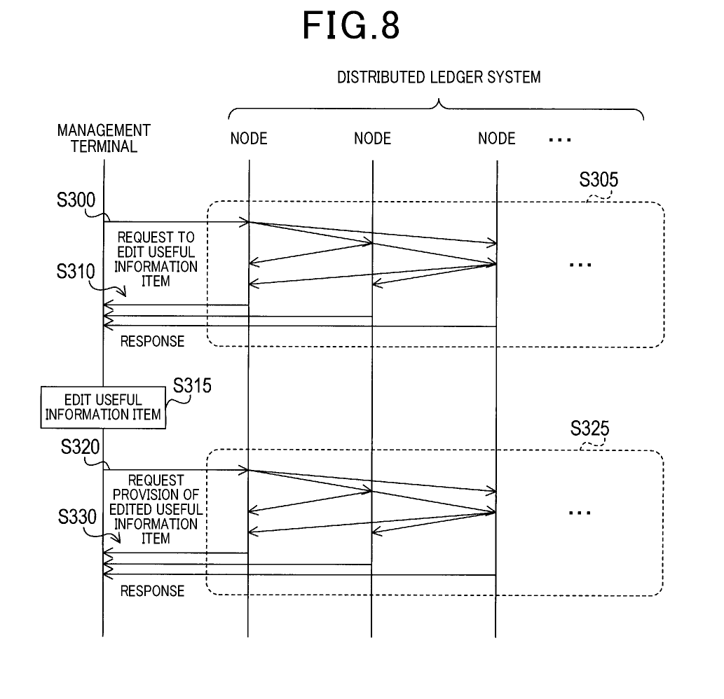

The following describes the transaction sequence to edit a useful information item registered in the distributed ledger system 2, and cause an edited useful information item to be providable from the distributed ledger system 2 with reference to FIG. 8.

When a manager operates the user I/F 41 of the at least one management terminal 4 to input a request to edit a specified useful information item, the at least one management terminal 4 communicates with a selected node 6 in the distributed ledger system 2 to thereby perform a transaction of posting the request in step S300.

The selected node 6 of the distributed ledger system 2 receives the edit request, so that a record indicative of the edit response transaction is registered in step S305.

Thereafter, each of the nodes 6 performs, in step S310, a response to the edit request to provide the specified useful information item to the at least one management terminal 4 directly or indirectly in the same approach as the operation in step S205.

Note that the record of the edit response transaction represents, for example, provision of the useful information item to the at least one management terminal 4 for edit.

Next, the at least one management terminal 4 receives the specified useful information items in accordance with manager's operations via the user I/F 41, and edits the specified useful information items in accordance with manager's operations via the user I/F 41 in step S315.

Thereafter, the at least one management terminal 4 provides the edited useful information item to the distributed ledger system 2 in response to a manager's instruction input from the user I/F 41 in step S320.

Specifically, the at least one management terminal 4 communicates with a selected node 6 in the distributed ledger system 2 to thereby send notification of the provision of the edited useful information item to the selected node 6 in step S320 in the same manner as the operation in step S205. Like step S205, the at least one management terminal 4 can send, as the notification, the useful information item itself to the selected node 6 directly or send the notification linked to the useful information item indirectly.

In the distributed ledger system 2, the selected node 6 communicates with the at least one management terminal 4 to receive the notification, and obtains, based on the notification, the edited useful information item in step S320.

Then, in step S325, the nodes 6 of the distributed ledger system 2 each register the record of the second transaction sequence.

Note that the record of the second transaction sequence can include the provision of the edited useful information, or the acquisition information about the edited useful information.

After the operation in step S325, in step S330, each of the nodes 6 sends, to the at least one management terminal 4, reporting registration of the record of the second transaction sequence, and permission for the provision of the edited useful information.

The at least one management terminal 4 provides, to a user, visible and/or audible information representing the response sent from each of the nodes 6 in step S330.

Note that a manager can directly operate any one of the nodes 6 in place of the at least one management terminal 4 thereby perform the second transaction sequence illustrated in FIG. 8 between the nodes 6.

### Transaction Sequence to Obtain Useful Information

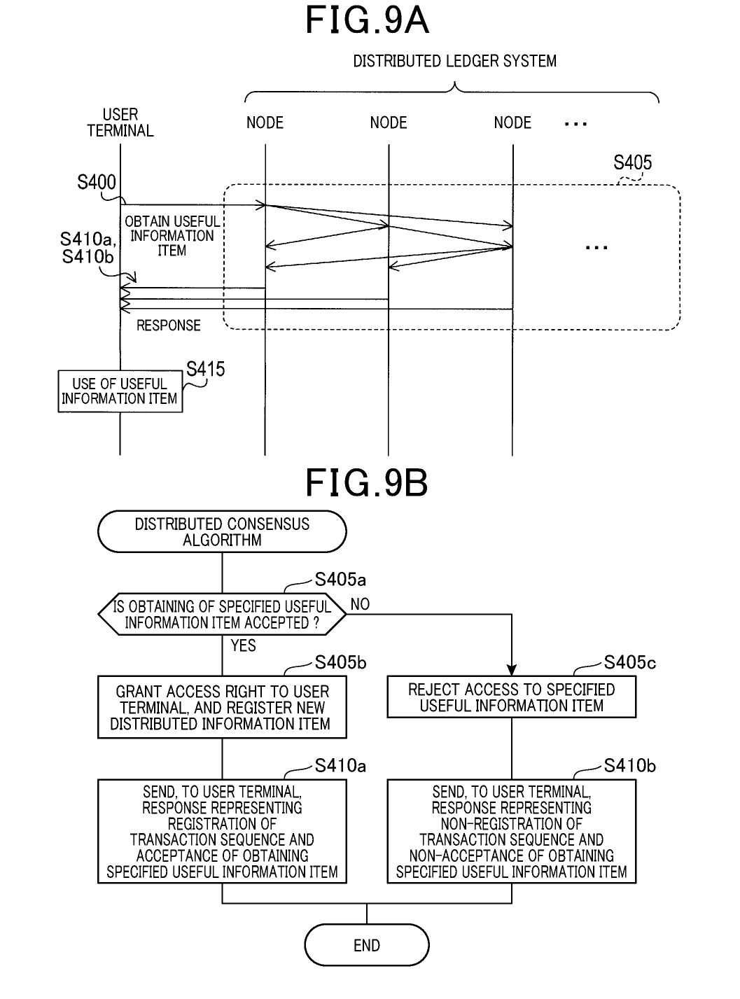

The following describes the third transaction sequence to obtain at least one useful information item registered in the distributed ledger system 2 with reference to FIGS. 9A and 9B.

The at least one user terminal 5 performs a transaction of obtaining obtain a specified useful information item from the distributed ledger system 2 in response to a user's instruction input from the user I/F 41 in step S400 (see FIG. 9A).

Specifically, the at least one user terminal 5 communicates with a selected node 6 in the distributed ledger system 2 to thereby send a request to obtain the specified useful information item in step S400. Note that the specified useful information item can be a non-edited useful information or an edited useful information item.

The selected node 6 of the distributed ledger system 2 receives the request, and determines whether to consent obtaining of the specified useful information in step S405.

In particular, because each of the nodes 6 stores the distributed consensus algorithm as described above, each of the nodes 6 is programmed to register the record of the third transaction sequence as the transaction information item into the storage 63 in accordance with the distributed consensus algorithm.

For example, the selected node 6 determines whether to accept obtaining of the specified useful information in accordance with whether a payment from the at least one user terminal 5 has been carried out in step S405a (see FIG. 9B).

Upon determining that the payment from the at least one user terminal 5 has been carried out (YES in step S405a), the selected node 6 grants an access right to the specified useful information item to the at least one user terminal 5 in step S405b. Then, the selected node 6 registers, into the corresponding storage 63, a record of the transaction sequence as a new distributed information item 100, and causes each of the other nodes 6 to register, into the corresponding storage 63, a record of the transaction sequence as a new distributed information item 100 in step S405b. Note that the record of the transaction sequence can include information indicating of an intention to obtain the specified useful information item, or acceptance of the provision of the specified useful information to the at least one user terminal 5.

After the operation in step S405b, each of the nodes 6 sends, to the at least one user terminal 5, a response indicative of registration of the record of the transaction sequence, and acceptance of obtaining of the specified useful information item in step S410a.

Otherwise, upon determining that the payment from the at least one user terminal 5 has not been carried out (NO in step S405a), the selected node 6 rejects access to the specified useful information item from the at least one user terminal 5 in step S405c.

After the operation in step S405c, each of the nodes 6 sends, to the at least one user terminal 5, a response indicative of non-registration of the record of the transaction sequence, and non-acceptance of obtaining the specified useful information in step S410b.

When receiving the response sent from each of the nodes 6, the at least one user terminal 5 provides, to a user, visible and/or audible information representing the response sent from each of the nodes 6 in step S410a or S410b.

Like the operation in step S205, if obtaining of the specified useful information item has been accepted, the specified useful information is supplied from the distributed ledger system 2 to the at least one user terminal 5.

Next, the at least one user terminal 5 obtains the specified useful information item from the distributed ledger system 2 in response to the visible and/or audible information if the response represents acceptance of obtaining of the specified useful information item in step S415. Then, the at least one user terminal 5 performs a task using the specified useful information item in step S415. Note that, if the acquisition information is supplied from the distributed ledger system 2 to the at least one user terminal 15, the at least one user terminal 15 obtains the specified useful information based on the acquisition information.

### Transaction Sequence to Post Trading Conditions

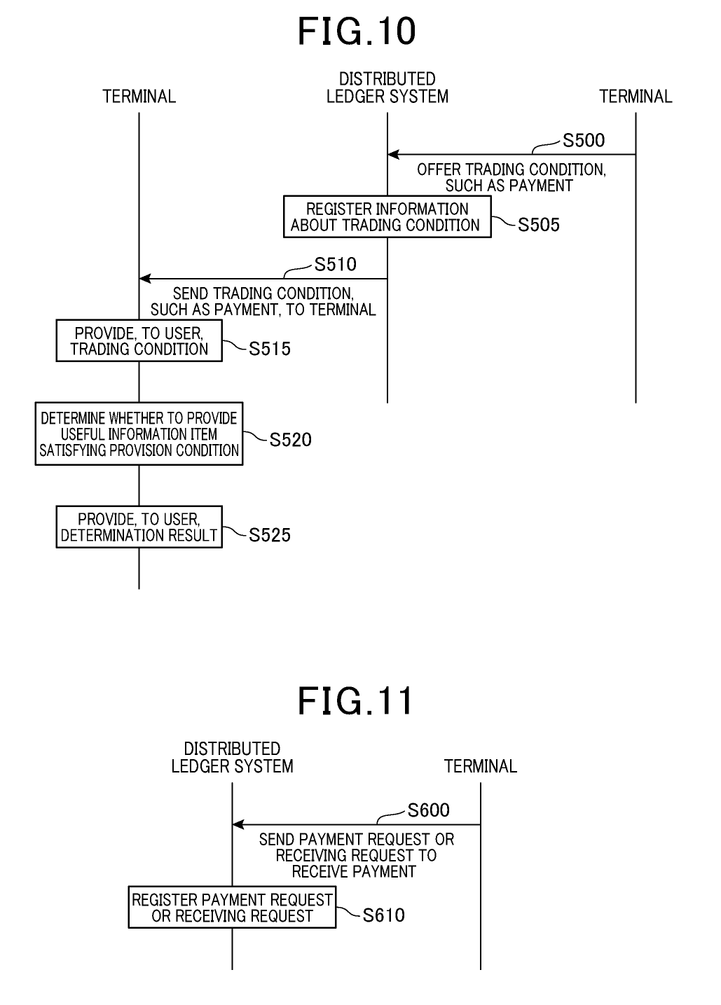

The following describes the transaction sequence to post trading conditions about at least one useful information item with reference to FIG. 10.

The trading conditions can include a price that should be paid upon provision of the useful information item, which will be referred to as price information. The trading conditions also can include a price that should be paid when obtaining the useful information item.

The trading conditions can include provision conditions that should be satisfied by a useful information item. The trading conditions can be posted from the at least one provider terminal 3, the at least one user terminal 5, or the at least one management terminal 4.

A terminal which is one of the terminals T performs a transaction of posting at least one trading condition to the distributed ledger system 2 in response to a user's instruction input from the corresponding user I/F in step S500.

The trading conditions are conditions associated with useful information items. For example, if a user has provided a useful information item to the distributed ledger system 2 from the at least one provider terminal 3, at least one of the trading conditions can be a price that should be payed to the user. As another example, if a user has obtained a useful information item from the distributed ledger system 2 via the at least one user terminal 5, at least one of the trading conditions can be a price that should be paid by the user. As a further example, at least one of the trading conditions can be the provision conditions for a useful information item that a user wants to use.

Specifically, the terminal in the terminals T communicates with a selected node 6 in the distributed ledger system 2 to thereby send the at least one trading condition to the selected node 6, in other words, the distributed ledger system 2, in step S500.

The selected node 6 of the distributed ledger system 2 receives the at least one trading condition, and a record of the transaction sequence is registered as a new distributed information item 100 in step S505. Note that the record of the transaction sequence indicates, for example, information that the at least one trading condition has been posted, or contents of the at least one trading conditions.

In step S510, one or more the nodes 6 notify the at least one trading condition to external devices. For example, one or more the nodes 6 communicates with at least one of the terminals T excluding the sender terminal to thereby notify the registered at least one trading condition to the at least one of the remaining terminals T. Note that such a notification may not only be carried out actively by the distributed ledger system, but also passively by responding to a query requesting the latest trading condition sent from a terminal. Or a terminal can just access one of the nodes 6 to refer to the latest trading condition, in which case such a notification is not necessary.

The at least one of the remaining terminals T that received the registered at least one trading condition informs contents of the trading condition to a user in step S515.

If the at least one trading condition is a provision condition, the at least one of the remaining terminals T determines, based on the received provision condition, whether the at least one of the remaining terminals T is capable of providing a useful information item that satisfies the received provision condition in step S520. Then, the at least one of the remaining terminals T provides, to a user, information indicative of the determination result in step S525.

Specifically, in step S525, the at least one of the remaining terminals T can determine whether the information satisfying the provision condition has been stored in the corresponding storage. In step S525, the at least one of the remaining terminals T can determine whether the useful information item satisfying the provision information is available from another device via the corresponding second communicator. Note that these operations can be carried out as transactions. If it is determined that the at least one of the remaining terminals T is capable of providing a useful information item that satisfies the received provision condition, the at least one of the remaining terminals T can perform a transaction to provide the useful information item to the distributed ledger system 2.

Note that trading conditions can be posted for each of various transactions independently of the above described transaction sequences. Trading conditions posted in, for example, each of the above transaction sequences, can be registered as a record in the distributed ledger system 2. It is assumed in certain cases that trading conditions for a specified useful information item have been registered as a record in the distributed ledger system 2. In such a case, if new trading conditions for the specified useful information item have been posted in various transaction sequences, the previously registered trading conditions are updated to the new trading conditions. This enables variations in trading conditions, such as payment information, for each useful information item to be reflected on the distributed ledger system 2 while the reliability of the transaction information items is ensured. The details of the updated trading conditions can be provided from the distributed register system 2 to users via terminals.

### Transaction Sequence Associated with Giving and Receiving of Payment Related to Trading of Useful Information

The following describes the transaction sequence associated with the giving and receiving of a payment related to trading of useful information with reference to FIG. 11.

If a useful information item has been provided to the at least one user terminal 5, a user of the at least one user terminal 5 is obligated to pay a price for using the provided useful information item. The payment can be paid to a user of the at least one provider terminal 3 who has provided the useful information item. If a useful information item has been edited, a payment can be paid to a manager of the at least one management terminal 4 who has edited the useful information item. As another example, if a user of the at least one provider terminal 3 has provided a useful information item to the distributed register system 2, a payment can be paid to the user of the at least one provider terminal 3 independently of whether the provided useful information item is used.

That is, the distributed ledger system 2 and the terminals T are configured to perform a payment giving transaction and a payment receiving transaction therebetween.

Specifically, a terminal in the terminals T can send a payment request to give a payment for a trading of a useful information item to a selected node 6 in the distributed ledger system 2 or send a receiving request to receive a payment for a trading of a useful information to a selected node 6 in the distributed ledger system 2 in step S600.

The selected node 6 of the distributed ledger system 2 can receive the payment request or receiving request. Then, a record of the transaction sequence is registered as a new distributed information item 100 into the corresponding storage 63 in step S610. Note that the record of the transaction sequence indicates, for example, information that giving or receiving of a payment has been performed, and the amount of the payment that has been given or received.

The distributed ledger system 2 can be programmed to have a payment function according to a first modification.

In this first modification, a terminal in the terminals T can send a payment request to give a payment for a completed transaction of a useful information item to a selected node 6 in the distributed ledger system 2 (see step S600). Then, the distributed ledger system 2 performs the payment function to pay to the sender terminal. Thereafter, a record of the transaction sequence is registered by the distributed ledger system 2 as a new distributed information item 100 (see step S610).

In this first modification, the payment function can be configured to

1. Access a server of a financial institution to execute the payment or

2. Give a payment using cryptocurrency

### Useful Information Item

Each useful information item that can be provided from the at least one provider terminal 3 satisfies the predetermined provision conditions set forth above. Each useful information item can be traded with the giving of a payment. For example, information items, each of which has attributes, and has been acquired at a specified time and a specified location, can become useful information items. The attributes of an information item include, for example, a type of the information item, such as an image or voice.

That is, the provision conditions of a useful information item indicate the details of the useful information item usable in transactions. The provision conditions indicate contents of useful information items that can be a subject of the trading, and can be registered as a transaction information item in the distributed ledger system 2.

Each useful information item can include an additional information item indicating that the useful information item satisfies the provision conditions. For example, if the provision conditions represent an image captured at a specified time and a specified location, a file of an image and the additional information item indicative of the time and the location at which the image has been captured can be traded as a useful information item.

If a navigation system is installed in the vehicle 7 as one of the in-vehicle devices 8a, the navigation system is capable of detecting, with high accuracy, the current location of the vehicle 7 using, for example, a known map matching function, and also measuring, with high accuracy, the current time using global positioning system (GPS) signals from GPS satellites. In addition, cameras are installed in the vehicle 7 as some of the in-vehicle devices 8a. An ECU incorporating therein a navigation system and/or cameras can be installed in the vehicle 7 as one of the ECUs 8.

If the at least one provider terminal 3 is installed in the vehicle 7, files each including an image captured by a corresponding one of the cameras and an additional information item can be used as high-value useful information items; the additional information includes an accurate time and location at which the image was captured measured by the navigation system.

The at least one provider terminal 3 can be configured to provide, to the distributed ledger system 2, useful information items, each of which is configured to, after being edited, become usable by the at least one user terminal 5. For example, images captured at specified locations can be provided to the distributed ledger system 2 as useful information items. Then, the useful information items each including an image and a specified location at which the image was captured can be edited by the at least one management terminal 4, to derive map information. Then, the map information items can be provided to the distributed ledger system 2 as useful information items. The files each including an image and a location at which the image was captured can be traded as useful information items. The useful information items can be edited by the at least one management terminal 4 and/or the nodes 6. The trading conditions of each useful information item can be registered in the distributed ledger system 2 as a transaction information item.

The following describes specific examples of such useful information items.

### 1. Useful Information Items Associated with Accident

Information items associated with an accident can be used as useful information items. Each of the useful information items in this case can include an image or sound captured around the scene of an accident within the time period including the occurrence of the accident. These useful information items can be used by the police and/or insurance companies as the evidence of the accident. A user can provide the provision conditions of these useful information items associated with an accident and/or payment information items for these useful information items associated with the accident to the distributed ledger system 2, and can register these provision conditions or payment information items as transaction information items.

Useful information items associated with an accident can be generated by the at least one provider terminal 3, the ECUs 8, and the in-vehicle devices 8a installed in the vehicle 7. Specifically, information items indicative of the situations around the vehicle 7 that was located close to the place of an accident at the time of the occurrence of the accident can be used as useful information items. The situations around the vehicle 7 can include, for example,

1. The conditions of traffic lights located around the place of the accident at the time of the occurrence of the accident

2. The number of vehicles located around the place of the accident at the time of the occurrence of the accident

3. The number of pedestrians located around the place of the accident at the time of the occurrence of the accident

4. The weather conditions at the place of the accident at the time of the occurrence of the accident

5. The conditions of damaged vehicle(s)

6. The conditions of occupant(s) in the damaged vehicle(s)

As such, the provision information items can include a condition that the information is generated based on information that was detected by the at least one provider terminal 3 or the ECUs 8 installed in the vehicle 7, given that the vehicle 7 was located close to the place of an accident at the time of the occurrence of the accident.

That is, images and/or sound information captured around the vehicle 7 can be used as useful information items. Recognition information about target objects, such as pedestrians and/or other vehicles, located around the vehicle 7, which were detected by for example a radar device, can be used as useful information items; the radar device is installed in the vehicle 7 as one of the in-vehicle devices 8a.

For example, information items indicative of the behaviors of the vehicle 7, which were detected by at least one of the in-vehicle devices 8a, can be used as useful information items. For example, the location, the speed, and the acceleration of the vehicle 7, which were detected by at least one of the in-vehicle devices 8a, can be used as useful information items. Images of the driver of the vehicle 7 captured by an in-vehicle camera can be used as useful information items; the in-vehicle camera is installed in the interior of the vehicle 7.

Each of the above useful information items may have something of value before the occurrence of accidents. For example, if captured images from roads have been registered as useful information items, these captured images can be browsed on the Web correlating with a road map, so that these captured images each have something of value. Transaction information items, each of which indicates the trading conditions including the payment information, can be registered in the distributed ledger system 2 independently of accidents. In such a case, the aforementioned user may perform the aforementioned transaction sequences after the occurrence of an accident to thereby update the payment information included in each of the transaction information items and registered in the distributed ledger system 2. That is, the occurrence of an accident can increase demand for each of the transaction information items, and therefore can increase the value of each of the transaction information items. In these cases, it is possible to register variations in the value of each useful information item in the distributed ledger system 2 while ensuring the reliability of the transaction information items 103. If the trading conditions, such as payment information, registered in the distributed ledger system 2 are updated, the updated trading conditions can be provided to users via some of the terminals T.

### 2. Useful Information Items Associated with Functions of Vehicle 7

Information items associated with usage conditions of the functions installed in the vehicle 7 can be used as useful information items. In other words, the provision conditions can include a condition that a useful information item is associated with the usage conditions of at least one function installed in the vehicle 7. The functions installed in the vehicle 7 can include, for example, functions of how the vehicle 7 is travelling, including a function of selecting the running modes of the vehicle 7, such as a power running mode and a regenerative mode. The functions installed in the vehicle 7 also can include, for example, various functions of a navigation system, an audio device, an air-conditioning system, and/or a seat adjusting device for each seat; these systems and devices are an example of the in-vehicle devices 8a installed in the vehicle 7.

These useful information items can be used by uses, such as manufactures of the components of the vehicle 7 as, for example, marketing information; these users can provide the provision conditions indicative of each of these useful information items to the distributed ledger system 2 to thereby register the provision conditions as transaction information items in the distributed ledger system 2.

The at least one provider terminal 3 installed in the vehicle 7 can be configured to obtain, via the LAN 7a, occupant's operations, such as driver's operations, of the components of the vehicle 7, such as the steering wheel and the in-vehicle devices 8a, to use at least one of the functions installed in the vehicle 7. Then, the at least one provider terminal 3 can be configured to provide the history of the occupant's operations to the distributed ledger system 2 as a useful information item to thereby register the history of the occupant's operations as a transaction information item in the distributed ledger system 2.

The at least one provider terminal 3 installed in the vehicle 7 can be configured to obtain, based on the occupant's operations, how often each of the functions is used, how each of the functions is used, and/or how timing each of the functions is used. Then, the at least one provider terminal 3 can be configured to provide the obtained information, usage situation information, about how often each of the functions is used, how each of the functions is used, and/or how timing each of the functions is used to the distributed ledger system 2 as a useful information item to thereby register the provided information as a transaction information item in the distributed ledger system 2.

### 3. Useful Information Items Associated with Environmental Situations Around Vehicle 7

Information items associated with the environmental situations around the vehicle 7 located in a specified place or in a specified place within a specified time zone, can be used as useful information items. That is, the provision information items can include a condition indicative of the environmental situations around the vehicle 7.

Specifically, the environmental situations around the vehicle 7 can include information about the weather conditions around the location of the vehicle 7, such as the ambient temperature, humidity, the amount of rainfall, and/or the wind velocity. These whether parameters, such as the ambient temperature, humidity, the amount of rainfall, and/or the wind velocity, can be measured by respective sensors included in the in-vehicle devices 8a. The amount of rainfall can be measured by the ECU 8 based on, for example, how wipers mounted to the vehicle 7 are being operated. The environmental situations around the vehicle 7 can include the level of noise around the vehicle, which can be measured by a sensor included in the in-vehicle devices 8a, and the concentration of contaminants in the air around the vehicle 7.

Information items associated with the environmental situations around the vehicle 7 located in a specified place where a disaster occurred at a specified time can also be used as useful information items. That is, the provision information items can include a condition indicative of these environmental situations around the vehicle 7. At that time, the environmental situations around the vehicle 7 can include information about the weather conditions around the location of the vehicle 7, such as the ambient temperature, humidity, the amount of rainfall, the velocity of wind, the size of an earthquake if the earthquake occurred as the disaster, and/or the amount of rainfall if a heavy rain occurred as the disaster. Images of the inside of the vehicle 7 located in a specified place where a disaster occurred at a specified time, which were captured by an in-vehicle camera, can be provided to the distributed ledger system 2 as useful information items; the in-vehicle camera is installed in the interior of the vehicle 7.

### 4. Useful Information Items Usable for Driving Assistance

Useful information items can include road information items usable for driving assist tasks. That is, the provision information items can include a condition that a useful information item indicates road information usable for the driving assist tasks of the vehicle 7 in which the at least one provider terminal 3 is installed or the driving assist tasks of other vehicles.

Note that the driving assist tasks can include, for example, an automatic driving task carried out by, for example, the ECU 8 and/or a navigation task carried out by, for example, a navigation system installed in the vehicle 7 as one of the in-vehicle devices 8a. The navigation task includes, for example, a task of guiding the vehicle 7 to a predetermined target place using at least one suitable route. The driving assist tasks can be carried out based on, for example, map information. The automatic driving means that at least part of the driving operations of the vehicle 7 can be automatically carried out.

Specifically, the road information items for example can include a distance from a point A to a point B; the distance can be calculated by the ECU 8 based on the speed of the vehicle 7 measured by one of the in-vehicle devices 8a. The road information items also can include where traffic signs on roads are located and include information items about the traffic signs. The road information items further can include where road markings on roads are located and include information items about the road markings. The road information items can include where pedestrian crossings and/or pedestrian bridges are located, or can include information indicative of how received-signal strength levels of radio waves used in radio communication systems are distributed.

These useful information items usable for the driving assist tasks can be used for users, such as map providers for the driving assist tasks. That is, these users can provide the provision conditions indicative of each of these useful information items to the distributed ledger system 2 to thereby register the provision conditions as transaction information items in the distributed ledger system 2.

### 5. Useful Information Items Associated with Recognition Results of Target Objects Around Vehicle 7

The ECU 8 installed in the vehicle 7 can be configured to perform a recognition task for recognizing target objects, such as other vehicles and/or pedestrians, around the vehicle 7 using, for example, at least one camera and/or a radar sensor installed in the vehicle 7 as the in-vehicle devices 8a. The recognition results obtained by the recognition task may include a result of unsuccessful recognition of target objects and/or recognized target objects with low accuracy. These recognition results obtained by the recognition task can be provided to the distributed ledger system 2 so as to be registered as useful information items. That is, the provision conditions can include a condition indicative of a recognition result of target objects around the vehicle 7 obtained by the ECU 8.

In the recognition task, it is estimated that machine learning can be carried out for improving the recognition accuracy. In this case, training data obtained during recognition of the target objects can be provided as useful information items.

These useful information items can be used by users, such as manufactures of the ECU 8. Each of these users can register the provision conditions indicative of these useful information items into the distributed ledger system 2.

### Effects

The above preferred embodiment achieves the following effects.

The trading system 1 according to the present embodiment is configured to register, into the distributed ledger system 2, a record of each of transactions of useful-information items as a transaction information item. In particular, the distributed ledger system 2 is configured to respectively register the transaction information items 103 into all the nodes 6 as distributed information items 100, thus sharing the same distributed information items 100 among all the nodes 6.

Each of the distributed information items 100 stored in each node 6 includes the corresponding transaction information item 103 and the unique information item 102 representing information uniquely generated by the node 6 based on a previous distributed information item 100 generated immediately previous generation of the corresponding one of the distributed information items 100.

That is, the distributed information items 100 sequentially stored in each node 6 constitute an information chain in which each distributed information item 100 is linked to the immediately previous distributed information item 100.

This configuration of the trading system 1 therefore makes it difficult to tamper with the distributed information items 100 stored in the distributed ledger system 2, thus ensuring the reliability of the transaction information items 103 included in the respective distributed information items 100.

That is, the trading system 1 is configured to accurately store a record of user's actions and user's intentions shown in a transaction of a useful information item in the distributed ledger system 2. This configuration prevents a user, who performs a transaction of the useful information item, from suffering unexpected disadvantage, even if the value of the useful information item has varied, because the record of the user's actions and user's intentions are shown in the transaction of the useful information item. This therefore enables users to perform, with security, transactions of the useful information items stored in the distributed ledger system 2, making it possible to invigorate transactions of useful information items.

The trading system 1 according to the present embodiment is also configured to register, into the distributed ledger system 2, a payment information item representing a payment that should be paid for the provision of a useful information item or that should be paid when the useful information item is used. This configuration therefore enables, even if the value of the useful information item has varied, a record of the variation in the value of the useful information to be saved, making it possible to ensure transparency and fairness in transactions via the trading system 1.

### MODIFICATIONS

The present disclosure is not limited to the above present embodiment, and can be variably modified.

One or more terminals in the terminals T can perform trading associated with a useful information item without the distributed ledger system 2 intervening in the transaction, and provide a notification of a record of the trading to the distributed ledger system 2 as a transaction. At that time, the distributed ledger system 2 registers the record of the transaction thereinto.

The at least one provider terminal 3 may not necessarily be designed as a mobile provider terminal. At least one of the nodes 6 included in the distributed ledger system 2 can be installed in a vehicle. At least one of the nodes 6 installed in a vehicle can be integrated with the at least one provider terminal 3 installed in the same vehicle.

The present embodiment is configured in such a way that, when a transaction is carried out between a terminal which is one of the terminals T and the distributed ledger system 2, a record of the transaction is registered in the distributed ledger system 2 as a transaction information item. The present embodiment however can be configured in such a way such that, when plural transactions have been carried out between a terminal which is one of the terminals T and the distributed ledger system 2, a transaction information item indicative of a record of the transactions is registered in the distributed ledger system 2. In addition, the present embodiment can be configured in such a way that, when one or more transactions have been carried out between a terminal which is one of the terminals T and the distributed ledger system 2 for a predetermined period, a transaction information item indicative of a record of the one or more transactions is registered in the distributed ledger system 2.

The functions of one element in the present embodiment can be implemented by plural elements, and the functions that plural elements have can be implemented by one element. The functions of plural elements in the present embodiment can be carried out by only one element, or a function implemented by plural elements can be implemented by a single element. At least part of the structure of the present embodiment can be replaced with a known structure having the same function as the at least part of the structure of the corresponding embodiment. A part of the structure of the present embodiment can be eliminated.

All aspects included in the technological ideas specified by the language employed by the claims constitute embodiments of the present disclosure.

The present disclosure can be implemented by various embodiments in addition to the trading system 1; the various embodiments include programs for serving a computer as the trading system 1, storage media, such as non-transitory media, storing the programs, and methods to be carried out by the trading system 1.

The at least one provider terminal 3, the ECUs 8, and/or the in-vehicle devices 8a serve as, for example, a detection device, and the first communicator 33 serves as, for example, a provider communicator or a terminal communicator. The first communicator 53 serves as, for example, a user communicator or a terminal communicator. The communicator 62 serves as, for example, a node communicator, and the storage 63 serves as, for example, a node storage.

The operations in steps S205, S320, S400, and S500 serve as, for example, a ledger execution unit and a node execution unit. The operations in steps S210, S325, S405, and S505 serve as, for example, a ledger storage unit and a node generate storage unit.

The operations in steps S205 and S500 serve as, for example, the provider execution unit, and the operations in steps S320, S400, S500, S510, and S520 serve as, for example, the user execution unit. The operation in step S510 serves as, for example, a ledger notifier, and the operation in step S515 serves as, for example, an information provider. The operation in step S500 serves as, for example, a terminal execution unit.

While the illustrative embodiment of the present disclosure has been described herein, the present disclosure is not limited to the embodiments described herein, but includes any and all embodiments having modifications, omissions, combinations (e.g., of aspects across various embodiments), adaptations and/or alternations as would be appreciated by those having ordinary skill in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. A trading system comprising:
a distributed ledger system; and
a plurality of terminals that includes at least one provider terminal and at least one user terminal,
the distributed ledger system comprising a plurality of nodes communicably connected to one another, the distributed ledger system being configured in such a way that each of the nodes has commonly stored a plurality of distributed information items therein associated with transactions related to useful information items,
the at least one provider terminal comprising:
a provider communicator communicable with a node; and
a provider execution unit configured to communicate with a node via the provider communicator to thereby perform processing for a transaction associated with a provision of a new useful information item through the distributed ledger system;
the at least one user terminal comprising:
a user communicator communicable with a node; and
a user execution unit configured to communicate with a node via the user communicator to thereby perform processing for a request of a transaction associated with a usage of a specified useful information item in the registered useful information items through the distributed ledger system;
the distributed ledger system comprising:
a ledger execution unit configured in such a way that:
any one of the nodes communicates with the at least one provider terminal to thereby execute processing for the corresponding one of the transactions; and
a ledger storage unit configured in such a way that:
at least one of the nodes generates a new distributed information item indicative of a record of each of the transactions; and
each of the nodes stores the new distributed information item,
the new distributed information item including:
a transaction information item indicative of the record of one or more of the transactions; and
a unique information item generated based on another distributed information item generated immediately before the new distributed information item.

2. The trading system according to claim 1, wherein:
the distributed ledger system is configured in such a way that each of the nodes stores a price information item indicating a price of the transactions;
the distributed ledger system comprises a ledger notifier configured to communicate with a selected terminal in the terminals via any one of the nodes to thereby notify the price information to the selected terminal; and
the selected terminal in the terminals comprises an informer unit configured to inform, to a user, the price information notified from the distributed ledger system.

3. The trading system according to claim 1, wherein:
each of the terminals includes:
a terminal communicator communicable with a node; and
a terminal execution unit configured to communicate with a node via the terminal communicator to send, to the distributed ledger system, at least one trading condition of at least one of the useful information items to thereby perform the transactions;
the at least one trading condition includes a condition associated with the at least one of the useful information items;
the ledger execution unit of the node is configured to:
perform a transaction to receive the at least one transaction condition; and
the ledger generation storage unit of the node is configured to generate a new distributed information item with a transaction information item indicative of a record of the at least one trading condition.

4. The trading system according to claim 3, wherein:
a condition that information tradable as a useful information item satisfies is defined as a provision condition; and
the at least one transaction condition includes the provision condition.

5. The trading system according to claim 4, wherein:
the terminal execution unit of the terminal is configured to:
communicate with the node to thereby obtain the provision condition from the node; and
determine whether a useful information item satisfying the provision condition is available from the terminal.

6. The trading system according to claim 1, wherein:
the at least one provider terminal is installed in a movable object including a detection device, so that the at least one provider terminal serves as at least one mobile provider terminal; and
the at least one mobile provider terminal is configured to provide, to the distributed ledger system, at least one of the useful information items, the at least one of the useful information items being generated based on at least one information item detected by the detection device.

7. The trading system according to claim 6, wherein:
a condition that information tradable as at least one of the useful information items satisfies is defined as a provision condition; and
the provision condition indicates a condition that the at least one of the useful information items was generated based on the at least one information item that was detected by the detection device when the movable object was located close to a place of an accident at a time of an occurrence of the accident.

8. The trading system according to claim 6, wherein:
the movable object has at least one function installed;
a condition that information tradable as at least one of the useful information items satisfies is defined as a provision condition; and
the provision condition includes a condition that the at least one of the useful information is associated with usage situations of the at least one function.

9. The trading system according to claim 6, wherein:
a condition that information tradable as at least one of the useful information items satisfies is defined as a provision condition; and
the provision condition includes a condition that the at least one of the useful information items indicates an environmental situation around the movable object.

10. The trading system according to claim 9, wherein:
the provision condition includes the condition that the at least one of the useful information items indicates the environmental situation around the movable object, the environmental situation around the movable object being a situation that the movable object was located in a specified place where a disaster occurred at a specified time.

11. The trading system according to claim 6, wherein:
a condition that information tradable as at least one of the useful information items satisfies is defined as a provision condition; and
the provision condition includes a condition that the at least one of the useful information items indicates a road information item used for a driving assist task of the movable object or another movable object located around the movable object.

12. The trading system according to claim 6, wherein:
a condition that information tradable as at least one of the useful information items satisfies is defined as a provision condition; and
the provision condition includes a condition that the at least one of the useful information items is associated with a recognition result of at least one other object located around the movable object.

13. A provider terminal communicable with a distributed ledger system of a trading system,
the distributed ledger system comprising a plurality of nodes communicably connected to one another, the distributed ledger system being configured in such a way that each of the nodes has commonly stored a plurality of distributed information items therein associated with transactions related to useful information items,
the provider terminal comprising:
a provider communicator communicable with a node; and
a provider execution unit configured to communicate with a node via the provider communicator to thereby perform processing for a transaction associated with a provision of a new useful information item through the distributed ledger system;
the distributed ledger system being configured in such a way that:
the node communicates with the provider terminal to thereby execute the transaction; and
at least one of the nodes generates a new distributed information item indicative of a record of the transaction; and
each of the nodes stores thereinto the new distributed information item,
the new distributed information item including:
a transaction information item indicative of the record of the transaction; and
a unique information item generated based on another distributed information item generated immediately before the new distributed information item.

14. The provider terminal according to claim 13, wherein:
the provider terminal is installed in a movable object including a detection device, so that the provider terminal serves as a mobile provider terminal; and
the mobile provider terminal is configured to provide, to the distributed ledger system, at least one of the useful information items, the at least one of the useful information items being generated based on at least one information item detected by the detection device.

15. A user terminal communicable with a distributed ledger system of a trading system,
the distributed ledger system comprising a plurality of nodes communicably connected to one another, the distributed ledger system being configured in such a way that each of the nodes has commonly stored a plurality of distributed information items therein associated with transactions related to useful information items,
the user terminal comprising:
a user communicator communicable with a node; and
a user execution unit configured to communicate with a node via the user communicator to thereby perform processing for a request of a transaction associated with a usage of a specified useful information item in the registered useful information items through the distributed ledger system,
the distributed ledger system being configured in such a way that:
the node communicates with the user terminal to thereby execute the transaction; and
at least one of the nodes generates a new distributed information item indicative of a record of the transaction; and
each of the nodes stores thereinto the new distributed information item,
the new distributed information item including:
a transaction information item indicative of the record of the transaction; and
a unique information item generated based on another distributed information item generated immediately before the new distributed information item.

16. A node included in a plurality of nodes of a distributed ledger system, the nodes being connected to one another, the distributed ledger system being configured in such a way that each of the nodes has commonly stored a plurality of distributed information items therein associated with transactions related to useful information items, each of the nodes being communicable with each of a provider terminal and a user terminal,
the node comprising:
a node storage configured to store the distributed information items;
a node communicator configured to communicate with other nodes and terminals;
a node executing unit configured to execute:
a provider request of a transaction provided from the provider terminal, the transaction being associated with a provision of a new useful information item via the distributed ledger system; and
a user request of a transaction provided from the user terminal, the transaction being associated with a usage of a specified useful information item in the registered useful information items via the distributed ledger system; and
a node storage unit configured to:
generate a new distributed information item indicative of a record of the transactions; and
store the new distributed information item in the node storage,
the new distributed information item including:
a transaction information item indicative of the record of the transactions; and
a unique information item generated based on another distributed information item generated immediately before the new distributed information item.
